(19) United States
(12) Patent Application Publication
(10) Pub. No.: US 2010/0212223 A1
(43) Pub. Date: Aug. 26, 2010

(54) Plant support with securing ring

(76) Inventor: Lloyd William Gibbons, Mardela Springs, MD (US)

Correspondence Address: Lloyd W. Gibbons, 11790 Sharptown Road, Mardela Springs, MD, 21837, US

(21) Appl. No.: 12/380,266

(22) Filed: Feb. 26, 2009

(51) Int. Cl. A01G 9/12; A01G 17/04

(52) U.S. Cl. 47/44

(57) ABSTRACT

A plant support with securing ring having a rigid unitary support comprising a lower, vertical, straight segment for pushing into earth and an upper support head shaped substantially as an incomplete circle, positioned horizontally and at a right angle to the lower segment of the same unitary component. In addition, a second component, an incomplete ring formed of semi-rigid material, a capture ring, significantly thicker than the upper support head incomplete circle material, contains a groove around the outer circumference which, when capture ring is rotatably placed within the incomplete circle in the upper support head of the rigid unitary support, receives incomplete circle which, in turn, holds capture ring in place while allowing capture ring to be rotated, thereby closing off the gap in the incomplete circles of both the capture ring and the upper support head, thus holding a plant stem securely within the closed circle form.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to devices for supporting the stem of a plant and, more particularly, a vertical device used to securely support and protect plant stems.

2. Prior Art

Many ornamental flowering plants such as irises, lilies, gladioli, roses, certain varieties of tulips and other species, commonly grow in height from two to four feet above ground level. After reaching full height, these flowers bloom at or near the top of the stem. This is the point at which the gardening and care of such plants result in the appreciation of the plant and the beauty of the blooms. This is also the point at which the stem can bend or even break at any point along its length. Such damage is usually caused by a combination of breezes or winds interacting with the large, wide blooms and the weight of the collective blooms. Such damage can also be caused by animal activity or persons tending the garden area or conducting other activities near subject plants. Additionally, some plants grow at an angle other than a vertical, optimal viewing angle due to growing habit, pressure from surrounding growth and/or static weight of the developing bloom buds and foliage. Any of these factors can cause the plant to present at an angle which is difficult to view especially when surrounded by other growth or fall to the ground and become completely unviewable. At this point, the plant cannot support itself and recovery of the plant to its fully vertical splendor, without additional support, is not possible. Although damage to plants or inability to view such plants is significant to hobbyists and home gardeners, such damage is especially significant in the case of floral and garden competitions where viewing and the appearance of competition-grade and prize-winning specimens is paramount.

Additionally, vegetable garden plants and fruit plants such as grape vines can be damaged, causing the plant stem to bend and the fruit of such plants can rest on the ground where the plant fruit can be easily damaged by insects or ground rot.

Historically, gardeners have used a variety of devices to support long-stemmed flowering and vegetable plants. Some primitive devices included sticks of wood or other readily available material and twine, string, wire, strips of cloth or other tying material used to lash the plant stem to the stick or other device. Such devices themselves can be easily damaged and fail and are generally not durable enough to be used for following seasons.

As a result, more sophisticated devices have been developed to attempt to support stems of flower, vegetable, and fruit plants. Gardening centers and gardening catalogs offer support devices similar to that represented in FIG. 5. U.S. Pat. No. 2,021,303, issued Nov. 19, 1935 to Grennan shows, in FIG. 2 accompanying the patent, the basic configuration of current devices. This prior art is the earliest example of this basic design that could be found by this inventor. U.S. Pat. No. 2,229,527, issued January, 1941 to Schouman shows, in FIG. 2 of the patent drawings, the basic design of the circular segment, design of the corrugated shaft and ground insertion point notwithstanding, which more closely represents current devices in design and proportion. Currently available devices are variably constructed of 5-gauge through 8-gauge wire and formed as shown in FIG. 5. In normal use, the straight, vertical, bottom segment of the device is pushed into the ground near the stem of the plant and the stem is then inserted through the opening in the circle and placed within the circle behind the short, straight section of wire within the circle to ostensibly capture the stem within the generally circular form and thereby support the plant stem in a more or less vertical position to display the blooms.

Support devices of this and similar designs suffer several disadvantages:

(a) Such devices are often ineffective immediately and must be removed and placed in a new position or fail to support the plant minutes or hours after placement. Such failure is due to one or more of several reasons. First, winds may blow the plant in such a way that the stem can fall out of the circle and will thus fall to the previous bent position or, worse, may break and fall to the ground since it may fall from a higher, vertical position. Second, the angle of the stem from vertical may prevent proper placement of the support initially if careful attention is not given to support placement and the plant can become dislodged from the circle as the plant reverts to its natural position. Third, movement of the plant and its stem by human or animal activity can cause the plant to become dislodged from its position within the circle and fall to the ground. These failures are the result of a lack of positive securing of the plant stem within the restraint.

(b) The restraining circle of available products is constructed variably of 5-gauge to 8-gauge metal wire. These measurements equate roughly to 4.62 mm (0.1819 inches) and 3.26 mm (0.1285 inches) respectively. Similar to the effect of a wire cheese slicer, the small diameter of wire relative to the larger diameter of the softer plant stem can, in and of itself, cause damage to the plant stem when the plant is buffeted by wind or other activity. Such damage can cause the stem to fail and fall over or become severed at the point of damage. This consideration is clearly illustrated in FIG. 6 of associated drawings wherein a cross-section of wire 10 such as used in currently cited supports is shown in juxtaposition with a plant stem 20 of representative thickness. When the plant is buffeted by winds or other activity, the plant stem frequently impacts the restraining ring repeatedly and damage 30, such as that illustrated in FIG. 6, can easily result. Such damage may be minimized only marginally with the addition of a thin plastic coating on the wire ring form because the coating increases the diameter of the wire negligibly. Damage from this cause is not limited to only rings and restraints of wire construction; the same type of damage can also be caused by twine, string or other material of relatively thin dimension when used to restrain the plant stem. U.S. Pat. No. 2,009,668, issued June 1935 to Lay, U.S. Pat. No. 1,976,094, issued October 1934 to Ritchie and U.S. Pat. No. 2,851,823, issued September 1958 to Peterson are examples of prior art wherein the segment which contacts the plant stem is constructed of wire and therefore can bruise and damage the softer plant stem of the very plant the device is intended to protect and show.

Further, other devices, both primitive and prior art, represented by patents U.S. Pat. No. 5,094,029, issued Mar. 10, 1992 to Packett, U.S. Pat. No. 6,973,751, issued Dec. 13, 2005 to Pierce, U.S. Pat. No. 6,454,244, issued Sep. 24, 2002 to Coulson and many others, involving large matrices constructed of stakes of various design and string, twine or other material, are not useful in these situations for several reasons:

(a) Although a significant portion of tall flower and vegetable plants require external support once they reach the flowering or fruiting stage, not all require such external support. Matrix-based support systems are applicable to relatively large areas, involving all the plants within that area and therefore are not applicable to specific, individual plants which need external support.

(b) Plant support systems involving matrices and trellises most often are obtrusive in appearance and detract from the beauty of the flowers being viewed. This is an important consideration in the case of home gardeners who wish to exhibit unique or prize specimens in their garden and even more important in the case of flower shows and competitions.

(c) Plant support systems involving matrices are time- and labor-intensive during setup and require the same for taking down the configuration once the growing season is ended. This is an especially significant drawback, given point (a) above.

Other designs, such as those represented in patents U.S. Pat. No. 3,113,400, issued December 1963 to Emond, U.S. Pat. No. 760,879, issued May 1904 to Kunzman and U.S. Pat. No. 4,005,548, issued Feb. 1, 1977 to Nahon are small, matrix-based systems and are not useful for this purpose because installation of such devices around individual plants which require external support can easily damage the already fragile plant since installation requires placement of the devices on at least two sides of the plant while, at the same time, manipulation of the plant stem, foliage, leaves, flowers and/or fruit. Such manipulation of the plant and placement of the device at the same time can easily damage the plant stem, flower and foliage thereby defeating the purpose of displaying it.

### SUMMARY OF THE INVENTION

In accordance with one embodiment, a plant support with securing ring comprises a unitary rigid support with a lower, straight, vertical segment for insertion into the earth proximate a plant requiring support and an upper, horizontal segment comprising a support ring which is an incomplete circle providing a gap for passage of a plant stem. The support ring rotatably encloses a capture ring, a separate piece of semi-rigid material, which is also formed into an incomplete circle, providing a gap for passage of same plant stem, with a groove formed on the outer circumference which receives the support ring which, in turn, frictionally holds the capture ring in position. The capture ring is formed and mounted so that it can be rotated within the outer support ring to close the circle and hold a plant stem securely within the closed circle.

Objectives of the current invention include:

(a) hold a plant stem in a vertical position,

(b) hold a plant stem securely,

(c) prevent damage to a plant stem while being held securely,

(d) provide a plant support which is easily installed for use and easily removed when its usefulness is ended,

(e) provide a plant support which minimizes the visual impact on plants being viewed and

(f) provide a plant support which manufacture is simple and of lowest cost possible relative to prior art yet meets the above objectives.

### BRIEF DESCRIPTION OF THE DRAWINGS

FIG. 1 is a perspective view of an embodiment of the present invention.

FIG. 2 is a top view of an embodiment of the present invention.

FIG. 3 is a cross-sectional view of capture ring 200 and support ring 150.

FIG. 4 is a perspective view of an embodiment of the present invention showing its intended use and method.

FIG. 5 is a perspective view of prior art commonly available in gardening catalogs and hardware stores.

FIG. 6 is a detailed view showing a cross-section of representative prior art support wire relative to a plant stem and potential damage area to a plant stem.

FIG. 7 is a cross-sectional view of capture ring 200, support ring 150, and a representative plant stem 20 and illustrates improved protection of the plant stem as afforded by capture ring 200 compared to prior art as illustrated in FIG. 6.

### DRAWINGS—REFERENCE NUMERALS

100 Unitary support

110 Vertical shaft

120 Support head

130 Right-angle bend

140 Offset

150 Support ring

160 Bend

170 Curl

200 Capture ring

210 Groove

220 Gap

230 Round

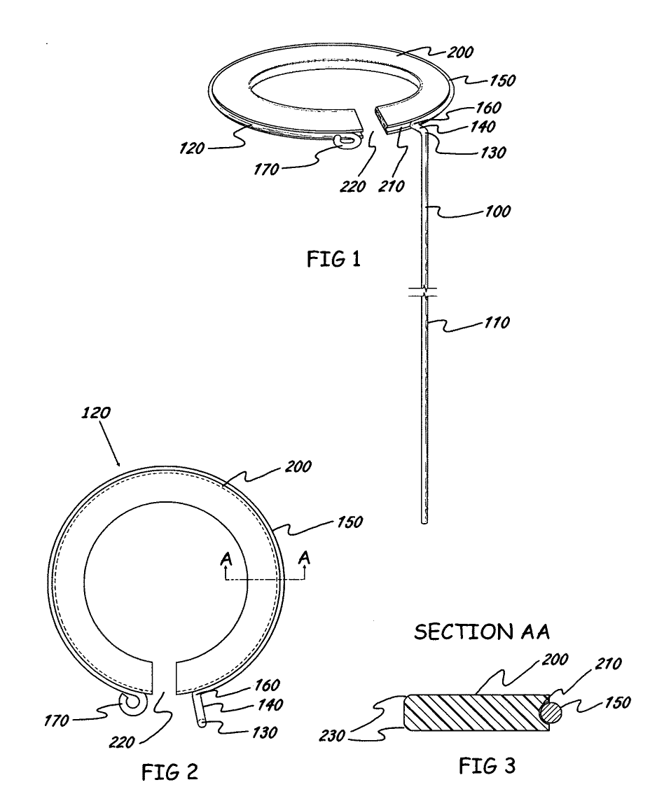

### DETAILED DESCRIPTION—FIGS. 1, 2 AND 3—PREFERRED EMBODIMENT

The preferred embodiment of the present invention is described herein with reference to accompanying drawings.

Referring to FIG. 1, a perspective view, the current invention is shown comprising:

(a) a unitary support 100 and

(b) a securing ring, capture ring 200

Unitary support 100 further comprises:

(a) a lower, straight, vertical shaft 110 and

(b) an upper support head 120

Lower vertical shaft 110 of support 100 is designed to be pushed into the earth near the stem of a plant to be supported with the device.

Support head 120 of support 100 begins at a right-angle bend 130 and further comprises:

(a) an offset 140

(b) a horizontally-oriented support ring 150, beginning at a bend 160, in the same plane as offset 140 and terminating with a curl 170.

Support ring 150 provides a gap for passage of a plant stem between bend 160 and curl 170.

Capture ring 200 is formed with a groove 210 in the exterior circumference and a gap 220. Groove 210 is provided in capture ring 200 to receive support ring 150 of horizontally-oriented support head 120. Gap 220 is provided to allow passage of a plant stem when gap 220 is aligned with the gap in support ring 150.

Referring to FIG. 2, a view of the top of the current invention, offset 140 is a transition from vertical shaft 110 of support 100 to horizontal support head 120.

Referring to FIG. 3, a cross-sectional view of capture ring 200 and support ring 150, shown is groove 210 in which support ring 150 of support 100 is shown and rounds 230 on interior circumference at top and bottom edges of capture ring 200, molded during initial manufacture of capture ring 200 or machined subsequent to manufacture. The purpose of rounds 230 is to minimize bruising of the plant stem and further damage after placement of stem in capture ring 200 by easing or relieving any sharp, right-angle corner on the interior circumference of capture ring 200 where there will be contact between the plant stem and capture ring 200. As shown in FIG. 3, for purposes of demonstration only, the thickness of capture ring 200, measured from the top to the bottom as shown, is significantly greater than the diameter of support ring 150. The illustrated ratio of capture ring thickness to support ring 150 diameter is nominal and can be varied to conform to manufacturing needs or material costs. Because the thickness of capture ring 200 is greater than the diameter of support ring 150, the plant stem is not subjected to the potential damage given the smaller diameter ring of conventional supports as described above. FIG. 7 demonstrates graphically the advantage of the thickness and rounded flat profile of capture ring 200 in protecting a plant stem opposite the lesser diameter of prior art as illustrated in FIG. 6.

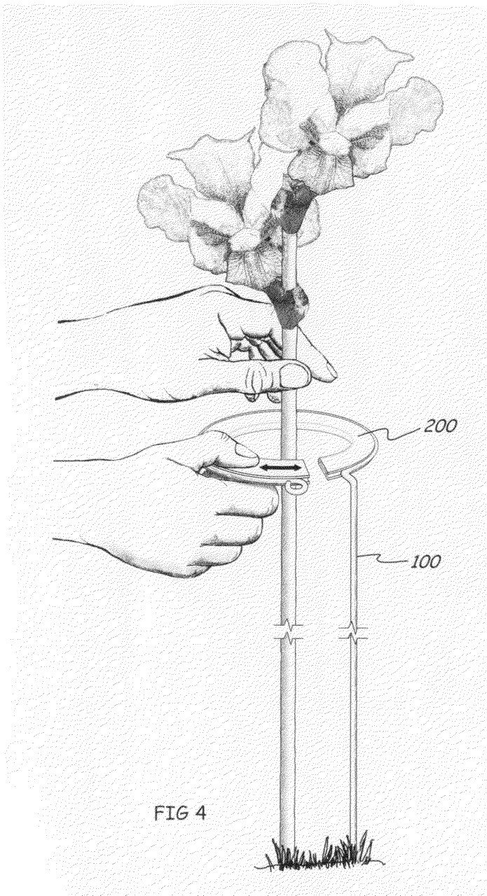

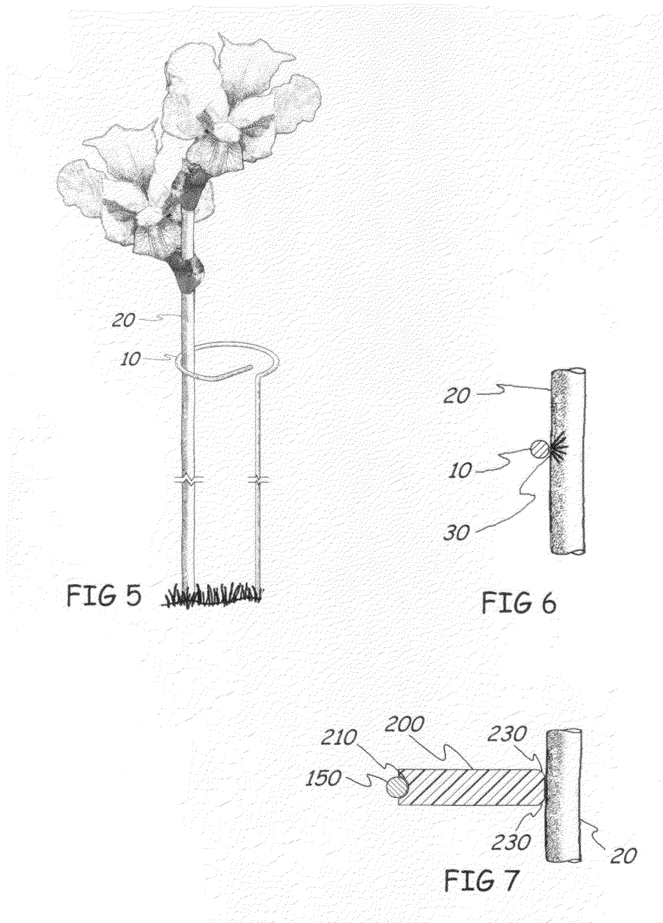

### Operation—FIG. 4

The manner of using the plant support with securing ring is illustrated in FIG. 4, a perspective view of the current invention showing its intended use. Lower, straight, vertical shaft 110 of support 100 is pushed into the ground near subject plant. The plant stem is manipulated into position through gap 220 in capture ring 200 so that the stem is placed inside the circle described by capture ring 200. Capture ring 200 is then rotated in either direction within support ring 150 until gap 220 is beyond curl 170 when capture ring 200 is rotated in that direction or until gap 220 is beyond bend 160 when capture ring 200 is rotated in that direction. Smooth rotation of capture ring 200 is aided by the radii of bend 160 and curl 170 whereas other design, such as abruptly ending support ring 150 without a radius, may hinder smooth rotation of capture ring 200. By such action, the plant stem is now securely captured within capture ring 200 and cannot be dislodged and can only be intentionally removed from the support.

After the flower blooms have faded, the flower has been cut for removal or vegetable fruit has been harvested, the plant support has served its purpose and can be easily removed for storage or to be used to support other plants throughout the growing season.

### Advantages

Given the foregoing descriptions, several advantages of the present embodiment of my plant support with securing ring become evident:

(a) With proper use of this device, a plant is held securely within its constraints so that it remains in a vertical position and is prevented from falling and sustaining damage.

(b) Use of the relatively thick semi-rigid capture ring in the design helps prevent damage to plant stems as opposed to the damage that can be caused by supports constructed of thinner wire, relative to the thickness of plant stems.

(c) When the device is no longer needed, it can be easily removed from the earth and stored or used to support another plant.

(d) Due to its light weight, simple construction and ease of use, it can be used by anyone.

(e) Manufacture of this device requires only two parts which minimizes production costs relative to more complex plant support systems.

(f) Use of this device is fast and easy since there is no requirement for on-site construction of complex support systems.

(g) During manufacture, length of the lower, straight, vertical segment of the rigid support can be varied to accommodate plant stems of a multitude of heights.

(h) During manufacture, length of offset 140 in FIG. 1 can be varied to offset support head 120 from lower segment 110. An increased offset will allow placement of lower segment 110 in the earth farther from the stem to minimize chance of damage to plant roots, bulb, rhizome or tuber.

### Conclusion, Ramifications and Scope of Invention

Accordingly, given the drawings and text, the reader will see that the current invention provides a device to securely and conveniently support a flowering or vegetable plant. The simplicity of design and use of the device allows it to be readily and conveniently removed from one plant when no longer needed and used to support another plant.

A preferred embodiment of support 100 is made of stainless steel, chromed steel or other metal of suitable gauge and material to retain its shape under use, to support a plant stem and plant top, including flowers or fruit, and for weatherability. Another consideration in choice of material for support 100 is that its surface be sufficiently smooth to allow smooth operation when capture ring 200 is rotated to enclose a plant stem.

A preferred embodiment of capture ring 200 is made of polyamide or polyolefin resin, such as high-density polyethylene or polypropylene, due to characteristics which allow such polymeric material to slide across metal more easily than other possible polymer resins, thereby allowing convenient and smooth rotation of capture ring 200 within support ring 150. This preferred embodiment should not be construed as limitations of the material for manufacture of capture ring 200 as other materials may also be used including, but not limited to, rigid vinyl, acrylonitrile butadiene styrene, acrylic and others.

Although the detailed description above contains many specifics regarding the current invention and its design, they should not be construed as limiting the scope of the embodiment but simply as illustration.

I claim:

1. A plant support with securing ring comprising:
an elongate unitary support of rigid material having a lower, vertical, straight segment for insertion into earth proximate a plant and an upper, horizontal segment comprising a support ring at a right angle to said lower, vertical, straight segment; and
a capture ring of semi-rigid material of predetermined thickness having a center void of predetermined diameter, a top surface, a bottom surface, an interior circumferential face, and an exterior circumferential face.

2. The plant support device of claim 1 wherein said elongate unitary support is fabricated from at least one of the materials taken from a list of materials including metal, plastic and wood.

3. The plant support device of claim 1 wherein said support ring of said upper, horizontal segment terminates in a curl exterior of and in the same plane of the rigid circle, thereby creating a gap in said rigid circle of predetermined width sufficient to allow passage of a plant stem of representative diameter.

4. The plant support device of claim 1 wherein said capture ring of semi-rigid material is fabricated from at least one of the materials taken from a list of materials including plastic, metal and wood.

5. The plant support device of claim 1 wherein said capture ring is formed with a circumferential groove on the exterior face of said capture ring of such dimension to rotatably receive and frictionally hold the support ring of said upper, horizontal segment of the unitary support.

6. The plant support device of claim 1 wherein said capture ring discontinues, thereby creating a gap in said capture ring of predetermined width sufficient to allow passage of a plant stem of representative diameter.

7. The plant support device of claim 1 wherein said capture ring is formed with rounds at top and bottom of the interior face of said capture ring of predetermined dimension sufficient to remove a perpendicular angle at a point where interior surface meets the top surface of said capture ring and where interior surface meets the bottom surface of said capture ring.

8. The plant support device of claim 5 wherein the dimensions of said circumferential groove on said capture ring and said support ring which is received into said circumferential groove are such that said capture ring is manually rotatable within confines of said support ring and remain within confines of said support ring, whereby a plant stem, when placed within the confines of said capture ring and said capture ring is rotated within said support ring, is secured within the resulting closed circle in a vertical position.
